(19) United States
(12) Patent Application Publication
(10) Pub. No.: US 2019/0017231 A1
(43) Pub. Date: Jan. 17, 2019

(54) SYNTHETIC GROUND COVER SYSTEM FOR EROSION PROTECTION

(71) Applicant: WATERSHED GEOSYNTHETICS LLC, Alpharetta, GA (US)

(72) Inventors: Michael Ayers, Alpharetta, GA (US); Jose Urrutia, Suwanee, GA (US)

(73) Assignee: WATERSHED GEOSYNTHETICS LLC, Alpharetta, GA (US)

(21) Appl. No.: 15/646,287

(22) Filed: Jul. 11, 2017

(51) Int. Cl. E01C 13/08; E02D 17/20; B32B 5/26

(52) U.S. Cl. CPC E01C 13/083; B32B 2250/20; B32B 5/26; E02D 17/202

(57) ABSTRACT

A synthetic turf cover system for covering various types of ground where water and wind erosion protection are needed includes a non-woven synthetic textile drainage layer and a woven textile layer positioned beneath and adjacent the non-woven synthetic textile drainage layer. A plurality of synthetic grass blades extend above the non-woven synthetic textile drainage layer and through the non-woven synthetic textile drainage layer and the woven textile layer, and the synthetic grass blades are tufted into the woven textile layer. The non-woven synthetic textile drainage layer can comprise a needle punched synthetic non-woven fabric or an air-laid synthetic non-woven fabric.

### BACKGROUND

The prior art discloses systems for erosion protection that typically take the form of a combination of a synthetic mat and natural grass. Additionally, the prior art generally requires multiple anchors to resist wind uplift and erosion forces on the synthetic mat. Thus, the industry continues to search for improved erosion protection systems which are effective, economical and meet the various local, state and federal environmental laws, rules and guidelines for these systems.

Artificial grass has been extensively used in sport arenas (playing fields) as well as along airport runways and in general landscaping. A primary consideration of artificial turf playing fields is the ability of the field to drain. Examples of prior art in synthetic grass drainage are U.S. Pat. Nos. 5,876,745; 6,858,272; 6,877,932 and 6,946,181. However, these applications are generally only for field playing surfaces where the ground is substantially flat and the concern is only with the ability to improve field playing conditions.

The drainage use in the prior art artificial turf deals principally with slow infiltration of flat surfaces to avoid inundation of the field, and such drainage use generally cannot handle the very large and rapid run-off that occurs on very large and steep side slopes of natural or man-made ground topography, such as landfills, stockpiles, berms, embankments, levees, drainage channels, mine tailing piles, etc.

### SUMMARY OF THE INVENTION

Briefly described, the present invention provides a new and useful system for covering various types of ground where water and wind erosion protection are needed. More particularly, the cover system of this invention comprises a synthetic turf cover system which includes a non-woven synthetic textile drainage layer and a woven textile layer positioned beneath and adjacent the non-woven synthetic textile drainage layer. A plurality of synthetic grass blades extend above the non-woven synthetic textile drainage layer and through the non-woven synthetic textile drainage layer and the woven textile layer, and the synthetic grass blades are tufted into the woven textile layer.

Optionally, the non-woven synthetic textile drainage layer can comprise a needle punched synthetic non-woven. Also optionally, the non-woven synthetic textile drainage layer can comprise an air-laid synthetic non-woven.

Preferably, the non-woven synthetic textile drainage layer is between about 2 mm and 30 mm thick.

Optionally, the woven textile layer is positioned for direct contact with a ground surface.

Preferably, the non-woven synthetic textile drainage layer is adapted for handling a high volume of precipitation runoff.

Preferably, the synthetic grass blades have a density of between about 10 ounces per square yard and 120 ounces per square yard. Preferably, the synthetic grass blades have a thickness of at least about 100 microns. Preferably, the synthetic grass blades comprise fibers with an average length of between about 0.5 and 3 inches.

Most preferably, the synthetic grass blades comprise fibers with an average length of between about 2 and 2½ inches.

The combination of the woven and non-woven textiles provide for lower permeability, better filtration from underlying sediment and multi-directional strength compared to known cover systems. The synthetic grass blades also serve to slow down water on slopes by increasing the hydraulic roughness coefficient.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

### BRIEF DESCRIPTION OF THE DRAWING FIGURES

FIG. 1 is a schematic, sectional view of a synthetic ground cover system according to the present invention.

FIG. 2 is a detailed schematic, sectional view of a portion of the closure system of FIG. 1.

FIG. 3 is a detailed schematic, sectional view of a portion of the closure system of FIG. 2.

### DETAILED DESCRIPTION

The present invention provides an erosion protection layer for use in embankments, levees, water channels, landfills and other steep topographic ground conditions.

In the present invention, a synthetic grass is used in combination with a non-woven synthetic textile drainage layer to provide a new and useful ground cover system, while also providing a beneficial erosion protection system that does not require maintenance. This combination (sometimes referred to as a composite material) can be used on covering slopes.

With the cover system of this invention, owners and operators can realize significant cost savings by constructing a cover system with synthetic grass that does not require the vegetative support and topsoil layer of the typical known final cover systems.

The cover system of this invention is preferably designed as a synthetic turf cover system which includes a non-woven synthetic textile drainage layer and a woven textile layer positioned beneath and adjacent the non-woven synthetic textile drainage layer. A plurality of synthetic grass blades extend above the non-woven synthetic textile drainage layer and through the non-woven synthetic textile drainage layer and the woven textile layer, and the synthetic grass blades are tufted into the woven textile layer.

With this invention, an anchoring system typically associated with exposed covers is optional. Moreover, the turf can be ballasted or not, as desired. If ballasted, one can ballast the turf with approximately about 0.5 to about 1.0 inch of sand infill, which produces a weight of about 5 to about 10 pounds per square foot.

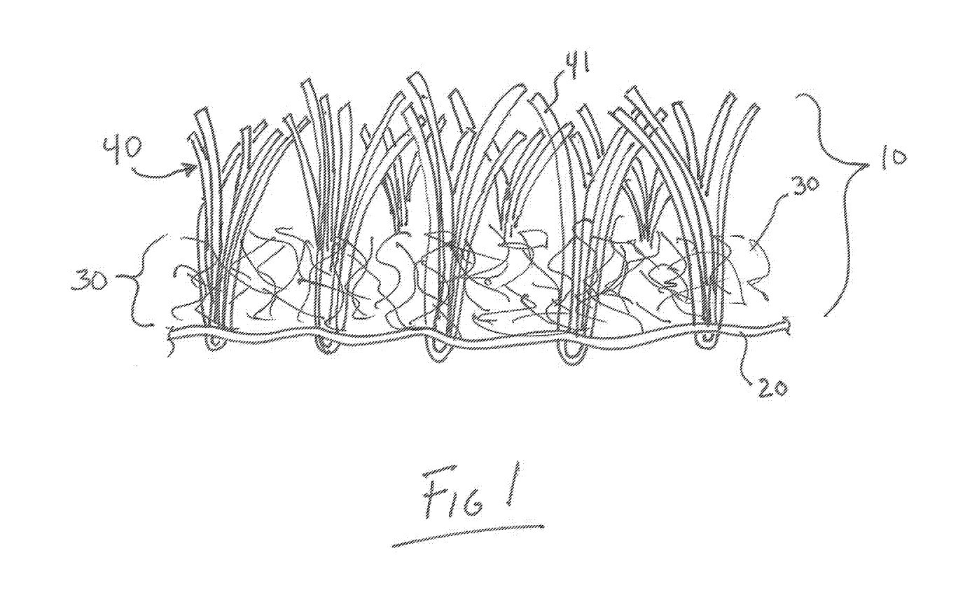

FIG. 1 is a schematic, sectional view of a closure system according the present invention and showing the soil surface covered with the present ground cover erosion control system 10. The system 10 includes a woven layer 20, non-woven layer 30 and a synthetic turf 40. Preferably, the non-woven layer 30 comprises a woven or non-woven synthetic fabric.

Preferably, the non-woven layer 30 comprises a synthetic drainage system with drainage capacity to handle high-intensity precipitation. The drainage system serves to prevent erosion of the ballast and/or the shearing stresses on the turf. This is different than prior art that uses gravel layers used in turf field applications.

Preferably, the non-woven synthetic textile drainage layer 30 comprises a needle punched synthetic non-woven. Preferably, the needle-punched non-woven synthetic textile drainage layer 30 comprises a polypropylene. Advantageously, the needle-punched non-woven synthetic layer is in the form of a relatively thick mat of fibers, which serve to absorb the small amount of rain precipitation, slow down infiltration and reduce the erosive force's impact on the soil subgrade.

Alternatively, the non-woven synthetic textile drainage layer 30 can comprise an air-laid synthetic non-woven fabric. The manufacturing process for making an air-laid synthetic non-woven fabric involves making a web of random fiber orientation while being formed and supported under air vacuum until the fibers are heat bonded together. Air-laid textiles provide much higher loft and more absorbency capacity than other non-wovens. This is desirable when used for applications having higher surface flow velocities.

Preferably, the non-woven synthetic textile drainage layer 30 is between about 2 mm and 30 mm thick. Preferably, the non-woven synthetic textile drainage layer 30 is between 2 and 15 mm thick. Most preferably, the non-woven synthetic textile drainage layer 30 is between about 10 and 15 mm thick.

Advantageously, the non-woven synthetic textile drainage layer 30 can provide excellent kinetic energy dissipation of the surface water flow. Also, the non-woven synthetic textile drainage layer 30 can provide excellent UV-protection. It is also useful for trapping sediment or for receiving fine soil (such as for ballast) to reduce any tendency to “wash out” or to “trampoline”. It also provides for excellent intimate contact with the soil subgrade, which further improves the performance of reduce erosion.

Preferably, the synthetic turf 40 is used as the upper component of the synthetic ground cover system. It can be constructed using a knitting or tufting machine that may use over 1,000 needles to produce a turf width of about 15 feet. Preferably, the synthetic turf includes synthetic grass blades 41 comprising polyethylene monofilament fibers tufted to have a blade length of between about 1½ inches and 4 inches. More preferably, the synthetic grass blades 41 are tufted to have a blade length of between about 2 inches and 3 inches. Most preferably, the synthetic grass blades 41 are tufted to have a blade length of about 2 to 2½ inches.

Optionally, the synthetic grass blades 41 are tufted to have a density of between about 20 ounces/square yard and about 120 ounces/square yard. Preferably, the synthetic grass blades have a thickness of at least about 100 microns.

The synthetic grass blades 41 are tufted through the non-woven layer 30 and the woven layer 20. Thus, the synthetic grass blades 41 are tufted to the woven layer 20. In this regard, the woven layer 20 acts as a substrate and provides excellent strength as a substrate. Optionally, a secondary backing (unshown) can be secured to the substrate/woven layer 20 to reinforce the substrate and better secure the synthetic grass blades thereto.

The chemical composition of the synthetic turf blades 41 should be selected to resist damage due to exposure to sunlight, which generates heat and contains ultraviolet radiation. Further, the polymer yarns should not become brittle when subjected to low temperatures. The selection of the synthetic grass color and texture should be aesthetically pleasing.

The actual grass-like components preferably consist of green polyethylene fibers 41 of about 2 to about 2.5 inches in length tufted into the woven geotextile layer 20. For added strength in severely steep side slopes, an additional mesh backing can be tufted for improving dimensional stability. The polyethylene grass filaments preferably have an extended operational life of at least 15 years.

Optionally, the synthetic turf is engineered to have polyethylene fibers with a length of 2 to 2.5 inches tufted into two fabrics consisting of needle punch non-woven polyester and woven polypropylene geotextiles. Optionally, a sand layer of about 0.5 to about 1.0 inches can be placed atop the synthetic turf as desired as infill to ballast the material and protect the system against wind uplift. The sand will provide additional protection of the geotextiles against ultraviolet light. Advantageously, the sand will sink down into the non-woven layer 30 and be largely hidden from view. However, preferably sand is not used and no additional ballast is employed to secure the cover system in place when the tufting gauge space density and pile height will provide UV screening protection of the underlying geotextile(s).

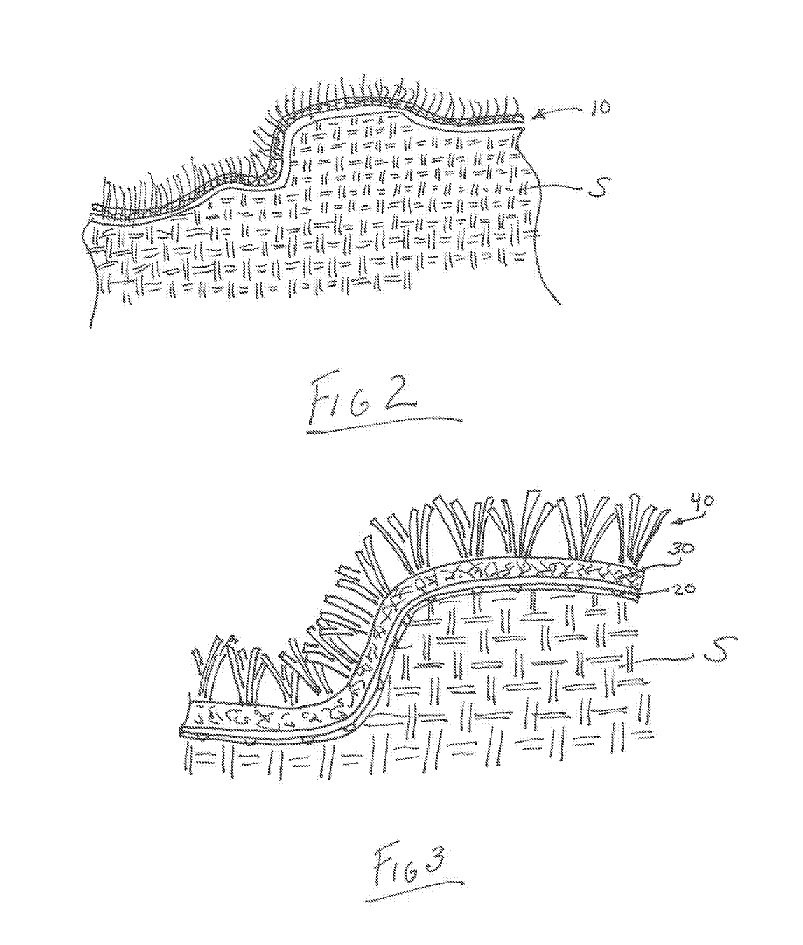

FIG. 2 is a detailed schematic, sectional view of a portion of the closure system of FIG. 1. Similarly, FIG. 3 is a detailed schematic, sectional view of a portion of the closure system of FIG. 2. These figures show the ground cover erosion control system 10 in contact with a very “rough” subgrade. This shows the product's physical flexibility as it “hugs” a very poorly graded ground. This intimate contact is known in the industry to be critical the performance of rolled erosion type products. As shown in these figures, the soil S is uneven and the ground cover erosion control system 10 closely follows the unevenly graded soil S, with the woven textile layer 20 closely abutting the top of the soil S.

This invention combines the use of a synthetic grass to provide a pleasant visual appearance, erosion protection with very minimal maintenance. The invention incorporates a synthetic drainage that can handle the very rapid run-off that provides the stability of the ballast and turf. Thus, the cover system of this invention can be installed on very steep slopes which typically occur in embankments, levees, dams, landfills and stockpiles.

The present invention serves as a highly effective cover and advantageously does so by dissipating energy and increasing the time of concentration of surface water flows.

There are many advantages to the cover system of this invention. The cover system reduces construction costs, reduces annual operation and maintenance costs while providing superior and reliable/consistent aesthetics. It also reduces the need for expensive riprap channels and drainage benches, with substantially no erosion or siltation problems, even during severe weather. It is a good choice in sensitive areas where soil erosion and sedimentation are major concerns because soil loss is substantially reduced. It also eliminates the need for siltation ponds and associated environmental construction impacts. It allows for steeper slopes, because there will be a reduced risk of soil stability problems, such as resulting from.

While the invention has been shown and described in exemplary forms, it will be apparent to those skilled in the art that many modifications, additions, and deletions can be made therein without departing from the spirit and scope of the invention as defined by the following claims.

What is claimed is:

1. A synthetic turf cover system for erosion protection, wherein the synthetic turf cover system comprises:
a non-woven synthetic textile drainage layer;
a woven textile layer positioned beneath and adjacent the non-woven synthetic textile drainage layer; and
synthetic grass blades extending above the non-woven synthetic textile drainage layer and through the non-woven synthetic textile drainage layer and the woven textile layer, the synthetic grass blades being tufted into the woven textile layer.

2. A synthetic turf cover system as claimed in claim 1 wherein the non-woven synthetic textile drainage layer comprises a needle punched synthetic non-woven.

3. A synthetic turf cover system as claimed in claim 1 wherein the non-woven synthetic textile drainage layer comprises an air-laid synthetic non-woven.

4. A synthetic turf cover system as claimed in claim 1 wherein the non-woven synthetic textile drainage layer is between about 2 mm and 30 mm thick.

5. A synthetic turf cover system as claimed in claim 1 wherein the woven textile layer is positioned for direct contact with a ground surface.

6. A synthetic turf cover system as claimed in claim 1 wherein the non-woven synthetic textile drainage layer comprises a synthetic drainage layer for handling a high volume of precipitation runoff.

7. A synthetic turf cover system as claimed in claim 1 wherein the synthetic grass has a density of between about 20 ounces per square yard and 120 ounces per square yard.

8. A synthetic turf cover system as claimed in claim 1 wherein the synthetic grass comprises blades with a thickness of at least about 100 microns.

9. A synthetic turf cover system as claimed in claim 1 wherein the synthetic grass blades comprise fibers with an average length of between about 0.5 and 3 inches.

10. A synthetic turf cover system as claimed in claim 1 wherein the synthetic grass blades comprise fibers with an average length of between about 2 and 2½ inches.
